(19) United States
(12) Patent Application Publication
(10) Pub. No.: US 2026/0254781 A1
(43) Pub. Date: Aug. 27, 2026

(54) Method and System for Public Display Management Using Rich Communication Services (RCS)

(71) Applicant: ORANGE, Issy-les-Moulineaux (FR)

(72) Inventors: Matthieu LIEWIG, CHATILLON CEDEX (FR); Joachim DELOYE, CHATILLON CEDEX (FR)

(21) Appl. No.: 19/547,901

(22) Filed: Feb. 24, 2026

(30) Foreign Application Priority Data
Feb. 24, 2025 (FR) FR2501895

(51) Int. Cl. H04L 51/02; H04L 12/18; H04L 51/10

(52) U.S. Cl. CPC H04L 51/02; H04L 12/185; H04L 51/10

(57) ABSTRACT

A public display system using the RCS protocol for broadcasting contextual information proposes creation of conversational agents for sending messages to display units, with a white list of agent identifiers authorized to send messages to these units. This system assures secured and standardized communication, simplifying the deployment and management of the public displays. It allows a rapid update of information, improving the accessibility and availability of the data for users, even remotely.

### CROSS REFERENCE TO RELATED APPLICATION

This application claims priority to French Patent Application No. FR2501895, filed February 24, 2025, the entire contents of which is incorporated herein by reference.

### TECHNICAL FIELD

The present disclosure comes from the field of communication technologies, more specifically the use of these technologies for broadcasting contextual information on public display systems.

### BACKGROUND

A public display system is a set of devices and technologies designed for broadcasting audiovisual information to a broad public in public or semipublic spaces. It generally includes digital screens or display panels, content management software, and communication means for data transmission. These systems are used for presenting contextual information—such as announcements, schedules, alerts, or advertisements—and may be deployed in various environments—such as train stations; airports; business centers; museums; city halls; bus, tram, or metro stations; and urban spaces. A modern public display system often incorporates advanced technologies in order to allow content updates in real time (in some cases, each minute), centralized management, and interaction with the public, while also providing security and reliability of the broadcast information.

In the current state-of-the-art, public display systems rest principally on Internet-based technologies, such as HTTP and FTP protocols for content broadcast. These systems often require complex infrastructure and customized software development for managing and updating displayed information. Existing solutions generally use centralized servers for distributing the content to the display screens, which may result in update delays and high maintenance costs. Since display systems are not standardized, deployment by an operator (e.g. mayor, transportation company) of a public display often requires launching a computer project, including software development and software integration that is often complex and costly.

Further, if the operator also wishes to broadcast the same contextual information directly to users, it is most often necessary to provide another information broadcast channel, in parallel with the proprietary channel dedicated to the public display units. It is not easy, for example, for users to receive the same information directly on their smart phone.

As a variant to solutions based on HTTP or FTP type Internet technologies, some public display systems use the LoRaWAN (Long-Range Wide-Area Network) radio communication protocol, which is an Internet of things communication protocol based on a proprietary technique of spectrum spread modulation. However, LoRaWAN technologies mainly target communications needing to transfer a small volume of data with a reduced data rate. Similar to traditional messaging technologies, such as SMS, they were therefore used in a limited manner because of their inability to manage rich and interactive multimedia content.

Consequently, there is a need for solutions for the management of public display systems that are more effective, secure and standardized.

### SUMMARY

A management method is proposed for a public display system, comprising creation of a list of identifiers of at least one conversational agent authorized to send messages via an Internet communication network to a set of at least one public display unit of the system, where the messages conform to the RCS (Rich Communication Services) rich message protocol.

According to another aspect, a public display system is proposed, comprising a set of at least one public display unit and one or more conversational agents, each configured for sending, via an Internet communication network, messages conforming to the RCS (Rich Communication Services) rich message protocol to said set of at least one public display unit of said system with which it is associated.

According to another aspect, a computer program is proposed, comprising instructions for implementing all or part of a method such as defined in the present disclosure when this program is executed by a processor. According to another aspect, a computer readable, nonvolatile support medium is proposed on which such a program is recorded.

Such a management method for a public display system allows standardized and secured communication between agents and public display units, which vastly simplifies the deployment and management of public display systems. By incorporating a list of identifiers of authorized agents, the system assures that only messages coming from verified sources are displayed, thus strengthening the security and reliability of the broadcast information. This method reduces the need for complex software development, thus also reducing the implementation costs and time. Further, by using the RCS protocol, a rapid and effective update of the information is possible, improving the user experience by providing data in real-time. The proposed architecture offers a more flexible and economic solution compared to conventional display systems based on nonstandard Internet technologies.

The characteristics disclosed in the following paragraphs may, optionally, be implemented independently of each other or in combination with each other:

Such a method further comprises generation of a message to be broadcast by one of the agents, and broadcast of the RCS message generated by the agent to the set of display units associated with them, and a display of the broadcast RCS message by the display unit from the set.

It is thus assured that the contextual information sent by the RCS protocol is effectively presented to the target public on the display screens. That guarantees that the rich messages, which may include text, images or other multimedia content, are made visible to the end users, for example on digital screens of public display units.

Such a method further comprises validation of the created conversational agents by an operator of the Internet communication network.

The security of the public display system is thus strengthened. In fact, this validation by the operator assures that only authorized conversational agents may send messages to the display units, thus blocking display of unauthorized or malicious content. This improves the reliability and integrity of the broadcast information, while also reducing the risk of external interference and manipulation. Consequently, the system becomes more robust and secure, providing reliable communication between the agents and the public display units.

The conversational agents are configured for managing group discussions and broadcasting the RCS messages in the group discussions.

The communication and broadcast of information to a broad public simultaneously and effectively are thus improved. By allowing conversational agents to manage group discussions, the system may broadcast rich messages to multiple public display units at the same time, which optimizes the use of network resources and improves the effectiveness of the information transmission. This also allows increased interaction and better management of communication in environments where multiple units of equipment or users must receive the same information in real time, like in public transportation or during events.

Such a method further comprises a subscription of at least one user to a group discussion within which the RCS messages displayed by one of the public display units are broadcast.

The scope of the information broadcast by the public display systems may thus advantageously be extended beyond the physical limits of the display screens. By allowing users to subscribe to group discussions, the system offers the possibility of receiving the same information directly on their personal devices, such as smart phones or tablets, even when they are not physically in front of the public display devices. This improves the accessibility and availability of the information, allowing users to remain informed in real time, wherever they are, and to plan their actions ahead based on the information received, like in the case of disruptions in public transportation, for example.

Such a subscription comprises a scan by the user’s communication equipment of a QR code placed near the public display unit.

The process of subscription to the discussion groups by the users is thus simple and easy. By using a QR code, the users may rapidly and easily subscribe to the pertinent information flows by simply scanning the code with their mobile device. This eliminates the need for complex subscription procedures or for manual information entry, which improves the user’s experience and encourages a broad adoption of the system. Further, this method assures that the user subscribes to the right information flow, because the QR code is specifically linked to the relevant public display unit.

Such a method further comprises validation of the created conversational agents by an operator of a mobile communication network to which the user is subscribed.

The security of the public display system is thus strengthened. In fact, this validation by the user’s operator guarantees the user that the RCS message flow to which they subscribed is reliable and legitimate, and that this subscription will not cause the user to receive spam or junk.

Such a method further comprises securing communication between the agents and the public display units comprising identification of the agents and authentication of the messages broadcast by a SIM card or eSIM integrated in the public display units.

By using a SIM card or eSIM for identification and authentication, the system assures that only the authorized agents may communicate with the display units, thus reducing the risk of unauthorized access and broadcast of malicious content. This approach strengthens the protection of the transmitted data and guarantees the integrity of the displayed information, while also maintaining secure and reliable communication between the various components of the system.

In such a public display system, each public display unit in the set comprises a display device, an RCS messaging application and an Internet communication means, where the units are configured for receiving and displaying messages coming from conversational agents and where such a system further comprises a module for generation (42) of an RCS message to be broadcast by one of the agents to the set of units associated with them. Such a system may be configured for implementing the management method described above, in all or part of the implementation variants thereof.

### BRIEF DESCRIPTION OF THE DRAWINGS

Other characteristics, details and advantages will appear upon reading the following detailed description and upon analysis of the attached drawings, on which:

FIG. 1 shows in synoptic schematic form a first application example of the public display management solution according to an embodiment.

FIG. 2 shows a public display management method in simplified flowchart form according to an embodiment.

FIG. 3 shows in synoptic schematic form another application example of the public display management solution in the context of a transportation network.

FIG. 4 shows an information system designed for managing a public display system using the RCS protocol according to an embodiment.

### DETAILED DESCRIPTION OF ILLUSTRATIVE EMBODIMENTS

The general principle of an exemplary embodiment of the present application rests on a public display solution using RCS (Rich Communication Services) technology for broadcasting contextual information about public buildings and urban equipment.

The rich communication services (RCS) are defined by the GSMA Universal Profile standard, which aims to replace traditional SMS by richer and more interactive messages. Multimedia messages can be sent with RCS, such as images, videos or files, and advanced functionalities are possible, like read confirmations, entry indicators and group discussions. This technology offers standardized and uniform communication, making interoperability between different operators and devices easier. RCS is designed for operating on mobile data and Wi-Fi networks, thus offering an improved user experience compared to conventional SMS. The GSMA Universal Profile standard assures that the RCS functionalities are compatible globally, thus allowing a broader adoption and integration in existing messaging services.

RCS Business Messaging is an advanced component of the Rich Communication Services protocol, which provides companies rich and interactive communication means with their clients. Unlike conventional SMS, RCS Business Messaging provides the possibility of sending multimedia messages, such as images, videos and files, while also incorporating advanced functionalities, like read confirmations and entry indicators. This technology allows companies to create more engaging and customized communication experiences, thus improving marketing, client support and other business interactions. By using RCS Business Messaging, companies may reach their clients directly on their mobile devices without needing additional applications, which simplifies the engagement and improves the effectiveness of communication campaigns.

The proposed approach is based on the functionalities provided by these RCS Business Messaging technologies. It resolves the disadvantages of prior solutions by allowing standardized and secure communication without needing complex software development. With the use of RCS messaging, information may be sent via a standard messaging application, allowing a rapid and effective update of the displayed content. Further, group messaging functionality allows a set of terminals to receive the distributed information simultaneously, thus improving the accessibility and efficacy of the communication. This method reduces installation and maintenance costs, while also offering flexibility for adaptation to different types of public equipment.

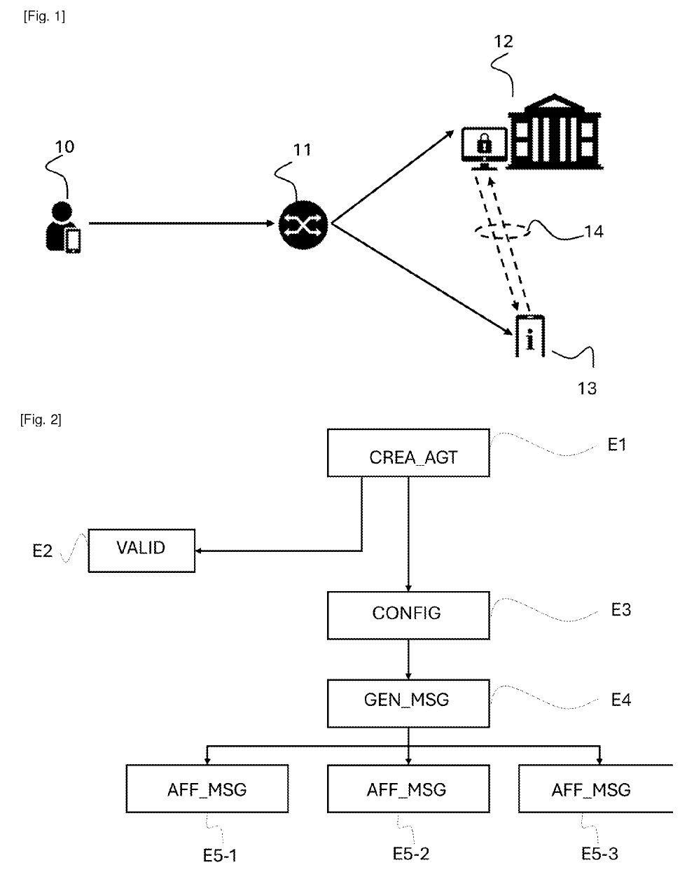

Now referring to FIG. 1, which shows in synoptic schematic form a first application example of such a public display management solution.

An example of application to a public place is considered, such as a museum 12 in which are placed one or more public display units. For example, these units are placed in the reception hall of the museum, and also in each of the galleries or collections of the museum. These display units, symbolized in FIG. 1, in the interest of simplification, as a single screen, are intended to broadcast various contextual information intended for the visitors.

In the museum 12, the proposed public display management method allows, according to an embodiment, transforming the experience of the visitors by offering contextual information in real-time via public display screens. For example, conversational agents may broadcast announcements about the current exhibits, schedules for guided visits or upcoming conferences. The visitors may also subscribe to group discussions to receive this information directly on their smart phones 13, even when they are not in front of a screen. By scanning a QR code near the displays, according to the step shown by the arrows referenced 14 on FIG. 1, visitors may easily sign up to receive personalized updates, thus improving their experience and their engagement with the museum.

To do this, an administrator or information system at the museum, with reference 10 on FIG. 1, sends RCS messages to all or part of the display devices of the museum 12. These messages pass through the RCS messaging infrastructure 11 of the telecom operator to the display units of the museum 12, where they are reproduced for the users, for example on digital display screens. The user who subscribed to the flow of conversations from one of the display units of the museum 12 may also receive these messages directly on their smart phone 13. They may thus, for example, be informed of a conference beginning in the gallery for this unit, even if they are in another wing of the building or the cafeteria of the museum.

The implementation of this solution rests on the public display management method shown in FIG. 2 in simplified flowchart form.

During a step referenced E1 (CREA_AGT), an administrator 10 defines one or more conversational agents. A conversational agent is defined as a computer program designed for interacting with users or other systems via communication interfaces, such as messaging applications. In the context of an exemplary aspect of the present disclosure, a conversational agent is a secured entity which serves as communication source towards one or more display units, allowing the transmission and management of messages with security and control. It is configured by an administrator 10 to define the scope of the display units which will receive the messages, and it is confirmed for a specific use and associated with a legitimate business.

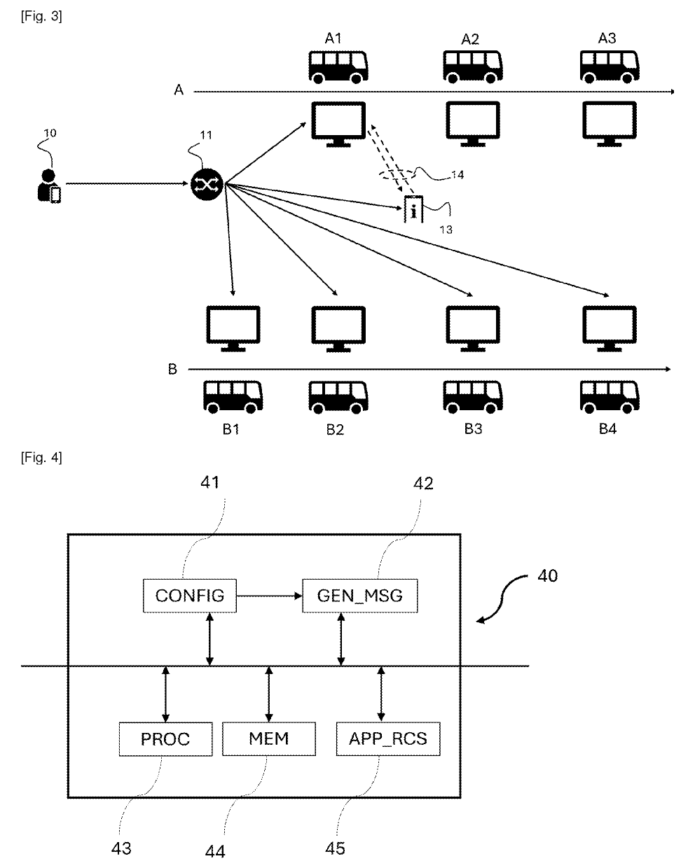

Referring to the example of application to an urban transportation network shown in FIG. 3, the administrator 10 creates, for example, during this step CREA_AGT E1 a global information agent for the transportation network, an agent for each of the bus lines A and B and an agent for each of the bus stops A1 to A3 and B1 to B4 of the bus lines A and B.

In an embodiment, the agents thus created are confirmed during a step referenced E2 (VALID) by one or more telecommunication operators, who verify that the transportation network management business is in fact authorized to communicate with these clients, specifically the display units which equip each of the bus stops A1 to A3 and B1 to B4, and also the users of this transportation network who may choose to subscribe to the RCS message flow broadcast by one of the created agents. With this validation E2, any malicious company can be turned aside and it assures that only legitimate companies may make use of the proposed solution.

According to a first aspect, this validation E2 may comprise a validation by the operator of the Internet communication network to which the transportation network management company subscribed for the set of its display units. In fact, these display units incorporate everything, beyond a physical display device, an Internet communication means, with which to authenticate the unit by means of a SIM card or eSIM, and an RCS messaging application.

A physical display unit is understood to mean a hardware device designed for visually presenting information in text, image or video form. In the context of an exemplary aspect of the present disclosure, a physical display unit is a unit incorporated in public display systems, such as a digital screen, which receives and displays messages transmitted by conversational agents via RCS technologies.

Internet communication means is understood to mean a device or technology with which to transmit data between devices over the Internet network. This includes technologies such as Wi-Fi, ethernet, 4G/5G/6G, or any other connection method which uses the IP protocol (Internet Protocol) for exchanging information. In the context of public display systems, an Internet communication means allows the display units to receive and send messages or data through the network, thus assuring an update of the displayed information in real time. In an embodiment, this Internet communication means rests on a SIM card or eSIM integrated in the public display unit.

A SIM card (Subscriber Identity Module) is an electronic chip used in mobile phones for storing identification information for the subscriber, such as the telephone number, security keys and data from the operator. It allows the device to connect to the mobile network of the operator and to take advantage of services such as calls, SMS and Internet access. An eSIM (embedded SIM) is a digital version of the traditional SIM card, directly incorporated in the device. It offers the same functionalities as the physical SIM card, but allows more flexible management of subscriptions. With an eSIM, the users may change operator or rate plan without having to insert or remove a physical card, simply by downloading a profile from the operator to their device. This technology is becoming more and more adopted in smart phones, tablets and connected devices, thus making connectivity and management of subscribers easier.

According to another aspect, the validation E2 may also comprise a validation of the agent by one or more other communication operators, who do not manage the embedded base of equipment for the transportation network management company, but before whom users have entered into a mobile telephone subscription. This or these operators may confirm the fact that the transportation network management company is a legitimate company and authorized to broadcast information to its subscribers, and confirm the created conversational agents, which allows users to be reassured that they will not receive spam messages if they choose to subscribe to the RCS flows offered by the transportation network.

In an embodiment, a software interface, or RCS Business Messaging console, is associated with each operator, and the administrator 10 declares its agents over all or part of these consoles, for validation by the associated operators. The administrator 10 may of course choose to exclude one of the operators if they wish, so as to refuse access by its subscribers to the RCS flows that it will broadcast via its conversational agents.

Returning to the flowchart from FIG. 2, the administrator 10 next configures, during a step referenced E3 (CONFIG), a white list of identifiers of authorized agents for each display unit A1 to A3 and B1 to B4.

For example, the display unit A1, which is located in the first bus stop of the line A, is configured for only receiving messages coming from confirmed and secure agents corresponding to the “General network information,” “Line A” and “Stop A1” agent. The identifier of the agent associated with line B is not, for example, part of the white list configured for the A1 display unit.

In an embodiment, this identifier is a phone number associated with the agent. The use of such a white list in a public display system has several advantages in terms of security and control of communications. By limiting communication to just conversational agents appearing on this list, the system blocks the display of unauthorized or malicious content, thus strengthening the security and integrity of the broadcast information. This reduces the risk of unauthorized access and handling of data, assuring that only verified and legitimate sources may interact with the display units. Further, the white list simplifies the management of communication by automatically filtering undesirable messages, which improves the reliability and quality of the information presented to the public.

During a step referenced E4 (GEN_MSG), a sender for the transportation network management company next uses its Business Messaging application for sending messages to all or part of each of its three types of agents, at the right moment, depending on the contextual information to be broadcast. Sender is understood to mean an entity, which may be human or an information system, responsible for sending messages via a conversational agent. The sender uses messaging tools for generating and transmitting contextual information to the public display units. These messages conform to the RCS protocol and may include text, images, video or other multimedia content. The sender plays a key role in the management and broadcast of information, by assuring that the messages reach the appropriate recipients securely and effectively.

For example, information such as “Strike notice for next Saturday” could be broadcast by the “General information for the network” agent; information of the type “Track work on the line B route from February 12 to 15” could be broadcast by the agent for line B (see multiple corresponding arrows in FIG. 3); information of the type “Bus 357 schedule for 2:55 PM: delayed two minutes” could be broadcast only by the A1 stop agent, where bus 357 should arrive at 2:55 PM, for display on the stop A1 screen (see corresponding single arrow on FIG. 3).

According to the conversation agent used for broadcasting an RCS message, this message is next displayed during steps referenced E5-1, E5-2 and E5-3 (AFF_MSG), on the physical display devices of the display units whose white list was configured for receiving the messages coming from this agent. Note the FIG. 2 shows a simple, nonlimiting example in which three displays are operated.

Thus, information generated by the sender during step E4 (GEN_MSG) may be sent via a standard messaging application, allowing a quick and effective update of all display devices of the transportation network from FIG. 3.

Further, with the group messaging functionality (“group chat”), a set of terminals 13 may receive information broadcast by the sender at the same time. The sending system returns to sending an RCS message to the targeted terminal, or to the group chat dedicated to a set of terminals 13.

In fact, as in the example from FIG. 1, the transportation network user may choose to subscribe (“opt in,” 14) to the RCS flows broadcast by all or some of the agents of the transportation network management company. For example, the user may choose to subscribe to conversations from the “General network information” agent and from the “Bus stop A1” agent, if this stop is the one they use daily to go to work.

In an embodiment, the QR codes are placed in bus stops, near displays, so users can subscribe to the RCS conversations of their choice. By scanning the QR code with their smart phone 13, users “opt in” so they can engage in the group conversation. Users may then receive the same content as the display device, without being in front of this display device. Thus, a user may, for example, be informed that there are going to be disruptions throughout the transportation network, because of a sports event or bad weather, and choose an alternative mode of getting around, like bicycle. The possibility of opening the “Machine-to-Machine” communication channel of the public display system is thus opened to physical people who are the users.

In an implementation variant, advertising messages may also be broadcast over the public display system, between the information messages. The broadcast of such advertising messages may generate a revenue source for the display system management company, which may help finance hardware investments to be made for display units (e.g. screen, SIM card).

FIG. 4 shows an information system 40 designed for managing a public display system using the RCS protocol, for example, the information system of the transportation network management company.

The information system 40 constitutes the central element which orchestrates all of the operations necessary to the management of the public displays. It comprises a memory 44, which stores the data necessary for the operation of the system—including the configurations, messages to be sent, and the security information—and a processor 43, which executes the instructions necessary for the operation of the modules and management of communications. It is the core of the information system, processing data and coordinating operations.

Such an information system 40 comprises a configuration module 41 for the conversational agent identifier list. This module is responsible for the management of the lists of agent identifiers authorized to send messages to the display units. It assures that only verified agents may communicate with the system, thus strengthening security.

It also comprises a message generation module 42. This component generates the RCS messages to be broadcast by the conversational agent. It confirms that the messages are correctly formatted and ready to be sent to the display units.

It also comprises an RCS messaging application 45, which manages sending and receiving RCS messages, providing fluid and effective communication between the conversational agents and the display units.

Together, these components allow the system to provide a secure and effective management of the public displays by using the RCS technology for broadcasting contextual information in real time.

### Industrial applicability

The present technical solutions may find application in particular in public administrations, transportation companies, museums, or any other organization wishing to broadcast communication to the public in real time.

They may, for example, be applied to management of a flow of visitors in a museum or an amusement park, by informing the public of congestion or wait times for this or that attraction, and by motivating users to move to less congested areas of the park, through real-time communication supported by RCS technology.

They have many advantages for the management of public display systems. They allow standardized and secure communication through the use of the RCS protocol, thus simplifying the deployment and management of the public displays. The conversational agents make the broadcast of contextual information in real time easier, improving user accessibility and engagement. Further, incorporation of white lists and operator validations strengthen the security of the communications, blocking the display of unauthorized content. Finally, the flexibility of the system allows easy adaptation to various public environments, thus reducing the installation and maintenance costs.

Further, an advantage of an exemplary aspect of the present disclosure resides in the simplicity of use provided by the RCS messaging application, which is preinstalled by default on standard communication equipment, such as Android smart phones. Unlike proprietary messaging applications, which will often require downloading and installing additional applications, the use of RCS eliminates this step, thus making immediate access to the rich messaging services easier. This native integration simplifies not only the process for the users, but also assures a broader and more homogeneous adoption of the technology, allowing fluid and uninterrupted communication between the various compatible devices.

An exemplary embodiment of the present disclosure improves the situation described in the Background section above.

The present disclosure is not limited to the examples described above, solely as examples, but it encompasses all variants which could be conceived by the person skilled in the art in the scope of the protection sought.

1. A method of managing a public display system, the method being performed by at least one device and comprising:
creating a list of identifiers of at least one conversational agent authorized to send messages via an Internet communication network to a set of at least one public display unit of said system,
where said messages conform to the RCS (Rich Communication Services) rich message protocol.

2. The method of claim 1, further comprising:
generating a message to be broadcast by one of said at least one conversational agent;
broadcasting said RCS message generated by said at least one conversational agent to the set of at least one display unit associated with the at least one conversational agent, and
displaying said broadcast RCS message by said at least one display unit from said set.

3. The method of claim 1, further comprising validating said at least one authorized conversational agent by an operator of said Internet communication network.

4. The method of claim 1, wherein said at least one conversational agent is configured to manage group discussions and broadcast said RCS messages in said group discussions.

5. The method of claim 4, further comprising subscribing at least one user to a group discussion within which said RCS messages displayed by one of said at least one public display units are broadcast.

6. The method of claim 5, wherein said subscribing comprises scanning, by communication equipment of said at least one user, a QR code placed near said one of said at least one public display unit.

7. The method according to claim 5, further comprising validating said at least one conversational agent by an operator of a mobile communication network to which the at least one user is subscribed.

8. The method of claim 1, further comprising securing communication between said at least one conversational agent and said at least one public display unit, which comprises identifying said at least one conversational agent and authenticating said messages broadcast by a SIM card or eSIM integrated in said at least one public display unit.

9. A non-transitory, computer-readable medium storing thereon instructions for managing a public display system, which when executed by at least one processor implement the method according to claim 1 .

10. A public display system comprising:
a set of at least one public display unit; and
at least one device comprising:
at least one processor; and
at least one non-transitory computer readable medium comprising instructions stored thereon which when executed by the at least one processor configure the at least one device to implement one or more conversational agents, each conversational agent being configured to send, via an Internet communication network, messages conforming to the RCS (Rich Communication Services) rich message protocol to said set of at least one public display unit of said system with which that conversational agent is associated.

11. The public display system, according to claim 10, wherein each public display unit in said set comprises a display device, an RCS messaging application and an Internet communication interface, where each public display unit is configured to receive and display messages coming from said one or more conversational agents and where said system further comprises a module configured to generate an RCS message to be broadcast by one of said one or more conversational agents to said set of at least one public display unit associated with said one or more conversational agents.

12. The public display system, according to claim 10 wherein the instructions configure the at least one device to create a list of identifiers of the one or more conversational agents, which are authorized to send the messages to said set of at least one public display unit.
